(19) United States
(12) Patent Application Publication
(10) Pub. No.: US 2012/0038566 A1
(43) Pub. Date: Feb. 16, 2012

(54) TOUCH DISPLAY DEVICE

(75) Inventor: Mengying LIN, Dali City (TW)

(73) Assignee: CHIMEI INNOLUX CORPORATION, Miaoli County (TW)

(21) Appl. No.: 13/162,087

(22) Filed: Jun. 16, 2011

(30) Foreign Application Priority Data
Aug. 11, 2010 (TW) 99126734

(51) Int. Cl. G06F 3/041

(52) U.S. Cl. 345/173

(57) ABSTRACT

A touch display device is provided. The touch display device includes a display panel, a plurality of horizontal sensing lines, a plurality of vertical sensing lines, a horizontal encoder, a vertical encoder, and a control chip. The display panel includes a plurality of sensing elements arranged in matrix form, and the plurality of the horizontal sensing lines and the plurality of vertical sensing lines are connected with the plurality of the sensing elements, respectively. The horizontal encoder receives and encodes a plurality of horizontal sensing signals from the plurality of horizontal sensing lines and thereby forms a plurality of horizontal encoded signals whose number is less than that of the horizontal sensing signals. The vertical encoder receives and encodes a plurality of vertical sensing signals from the plurality of vertical sensing lines and thereby forms a plurality of vertical encoded signals whose number is less than that of the vertical sensing signals. The control chip receives and processes the horizontal encoded signals and the vertical encoded signals to obtain coordinates of a touch position on the display panel.

### FIELD OF THE INVENTION

The present invention relates to a touch display device, and more particularly to a touch display panel with reduced frame width.

### BACKGROUND OF THE INVENTION

The use of touch display devices can not only conserve the space for deploying conventional mouse and keyboard, but also provide more user-friendly operations, therefore becoming one of the major interfaces of the electronic devices or machines. Currently, the in-cell touch technology integrating the touch sensing element into the pixel structure can provide better contrast and brightness than the conventional touch display device and thus receives more and more attentions.

FIG. 1 illustrates the pixel structure 100 of a conventional touch display device, wherein the pixel structure 100 includes three sub-pixels: red (R), green (G), and blue (B). In general, each sub-pixel 110, 120, 130 includes a transistor and a pixel electrode and is driven by a gate line 140 and one of the three data lines 150, 152, and 154. For touch sensing function, each pixel structure is disposed with two sensing elements 160 and 162, which sense x coordinate and y coordinate of the touch point, respectively. The structure of sensing elements 160 and 162 is typically a protrusion between the upper color filter substrate and the lower TFT array substrate of the display panel. When under pressing, the protrusion electrically conducts the upper substrate with the lower substrate. Thus, when an object touches the display panel, the sensing elements 160 and 162 of the pixel structure 100 corresponding to the touch position will generate a corresponding signal, wherein the signal can be transmitted to other circuitry of the display panel through the sensing lines 170 and 172 for further processing.

FIG. 2 illustrates a block diagram of the conventional touch display device 200. The display device 200 includes a display panel 210, Y-direction sensing circuits 220 and 222, an X-direction sensing circuit 230, gate-line driving circuits 240 and 242, a data line driving circuit 250, and a control chip 260. The display panel 210 includes a plurality of pixel structures of FIG. 1 arranged in matrix form, wherein the gate-line driving circuits 240, 242 and the data line driving circuit 250 update the display data in each pixel structure of the display panel 210. The horizontal sensing element in each pixel structure (e.g. the sensing element 160 of FIG. 1) is connected to the X-direction sensing circuit 230 through 2ⁿ sensing lines X(1), X(2), . . . , X(2ⁿ). The vertical sensing element in each pixel structure (e.g. the sensing element 162 of FIG. 1) is respectively connected to the 2^{m} sensing lines Y(1), Y(2), . . . , Y(2^{m}), wherein the odd number sensing lines Y(1), Y(3), . . . , Y(2^{m}−1), total 2^{m-1} sensing lines, are connected to the Y-direction sensing circuit 220, while the even number sensing lines Y(2), Y(4), . . . , Y(2^{m}), total 2^{m-1} sensing lines, are connected to the Y-direction sensing circuit 222. The control chip 260 receives and processes signals from the 2ⁿ sensing lines of the X-direction sensing circuit 230, signals from the 2^{m-1} sensing lines of the Y-direction sensing circuit 220, and signals from the 2⁻¹ sensing lines of the Y-direction sensing circuit 222 to obtain data associated with the touch position on the display panel 210.

Referring to FIG. 2, in order to prevent one side frame width of the touch display device 200 from widening, the sensing lines Y(1), Y(2), . . . , Y(2^{m}) are connected to two sides (e.g. left and right sides) of the display panel 210, respectively. However, the Y-direction sensing circuit 220 or 222 still needs to output 2^{m-1} sensing lines to the control chip 260. Such huge amount of sensing lines will result in overlarge frame width (D). Moreover, the control chip 260 also requires a large amount of pins for receiving sensing signals. As the resolution of display panel 210 is promoted, the above problems become more serious.

Therefore, there is a need to provide a sensing circuit structure capable of effectively reducing the frame width of the touch display device and decreasing the amount of the pins required in the control chip.

### SUMMARY OF THE INVENTION

Accordingly, the present invention has been made keeping in mind the above problems occurring in the prior art, and one aspect of the present invention is to provide a touch display device, which includes a digital logic circuit to significantly reduce the routing of the signal lines.

In one aspect of the present invention, by means of the digital logic circuit, the X-direction sensing lines and the Y-direction sensing lines in the touch display device are converted into signal lines in fewer amounts for outputting to the control chip. Due to the fewer amounts of the signal lines, not only the number of outputted signal lines can be reduced, but also the number of pins required in the control chip is decreased.

In one embodiment, the present invention provides a touch display device. The touch display device includes a display panel, a plurality of horizontal sensing lines, a horizontal encoder, and a control chip. The display panel includes a plurality of sensing elements arranged in matrix form, wherein the plurality of horizontal sensing lines are connected to the plurality of sensing elements, respectively. The horizontal encoder is coupled to the plurality of the horizontal sensing lines and provided for receiving and encoding a plurality of horizontal sensing signals from the plurality of horizontal sensing lines to output a plurality of horizontal encoded signals. The number of the plurality of horizontal encoded signals is less than the number of the plurality of horizontal sensing signals. The control chip is provided for receiving the plurality of horizontal encoded signals to obtain data associated with a touch position on the display panel.

In another aspect, the present invention provides an electronic apparatus including the touch display device described above, wherein the electronic apparatus is a mobile phone, a digital camera, a personal digital assistant, a laptop computer, a desktop computer, a television, a global positioning system, a head-up display, an aviation display, a digital frame, or a portable DVD player.

Other aspects of the present invention solve other problems and are disclosed and illustrated in detail with the embodiments below together with the aforesaid aspects. Various aspects of the present invention can be understood and implemented with the elements and combinations specified in the accompanied claims. However, it should be understood the foregoing contents and the following detailed description are only illustrative and not in a limited sense.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. While the invention is illustrated with preferred embodiments, those skilled in the art will understand the present invention is not limited to arrangements and elements described therein. In the drawings:

FIG. 1 illustrates a pixel structure of a conventional touch display device;

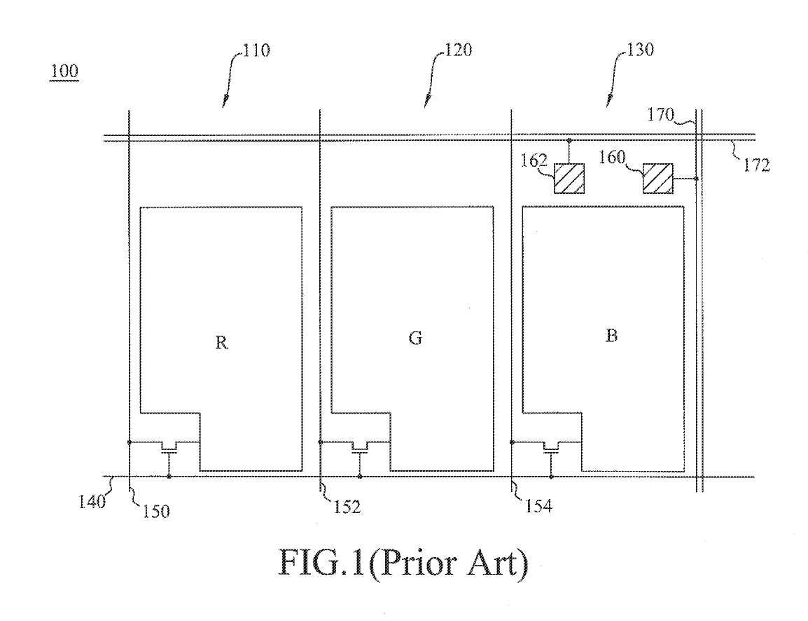

FIG. 2 illustrates a block diagram of a conventional touch display device;

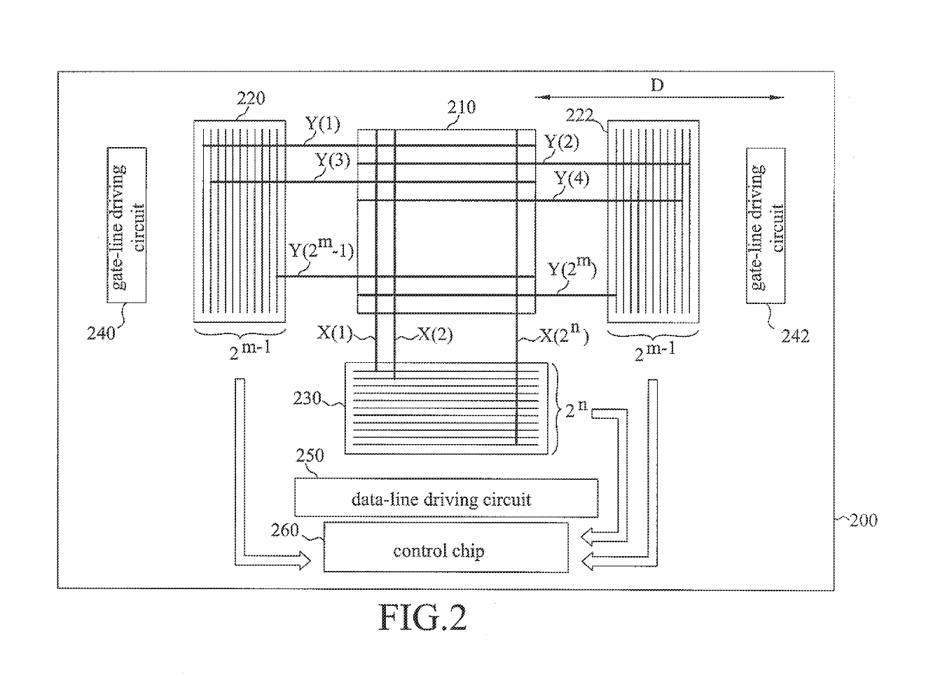

FIG. 3 is a block diagram of a touch display device in accordance with one embodiment of the present invention;

FIG. 4 illustrates logic circuit diagrams of a 4-to-2 encoder and a 8-to-3 encoder; and

FIG. 5 illustrates a touch display device in accordance with another embodiment of the present invention.

### DETAILED DESCRIPTION OF THE INVENTION

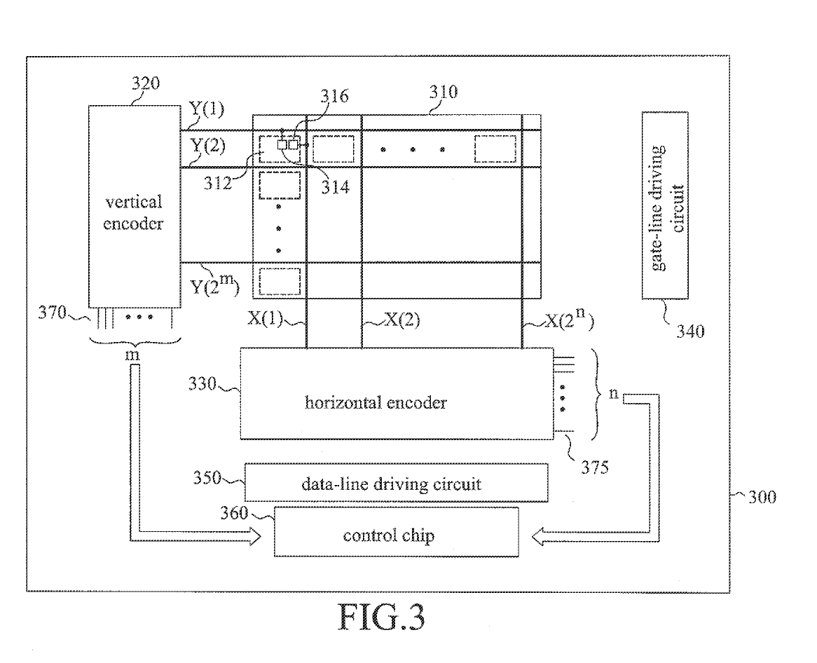

The present invention discloses a touch display device including at least one digital logic circuit for reducing the number of signal lines connected to the control chip to further reduce the frame width of the display device. The preferred embodiments of the present invention will now be described in greater details by referring to the following descriptions in reference with FIG. 3 through FIG. 5. The devices, elements, and processing steps described in the following embodiments are provided to illustrate the present invention and are not intended to be restrictive of the scope of the present invention.

FIG. 3 is a block diagram of a touch display device 300 in accordance with one embodiment of the present invention. The touch display device 300 includes a display panel 310, a vertical encoder 320, a horizontal encoder 330, a gate-line driving circuit 340, a data-line driving circuit 350, and a control chip 360.

The display panel 310 includes a plurality of pixel structures 312 consisting of a TFT array substrate, a color filter substrate, and a liquid crystal layer sandwiched between the two substrates. In general, each pixel structure 312 can include three sub-pixels: red (R), green (G), blue (B), and each sub-pixel includes a thin film transistor (TFT) and a pixel electrode. The structure and function of elements in the pixel structure 312 are similar to those in the conventional liquid crystal display and will not be elaborated hereinafter.

In the embodiment, the display panel 310 is an in-cell touch panel, i.e. the sensing element is built in each pixel structure. Referring to FIG. 3, the pixel structure 312 includes a vertical sensing element 314 for sensing vertical position and a horizontal sensing element 316 for sensing horizontal position. The sensing elements 314 and 316 of the present invention can be any built-in sensing element commonly used in the touch panel, such as a protrusion structure between the TFT array substrate and the color filter substrate. When an object touches the display panel 310, the sensing element corresponding to the touch position will electrically conduct the TFT array substrate and the color filter substrate, so as to determine the coordinates of the touch position by detecting the voltage drop caused by the short-circuit of the two substrates. It is noted that though each pixel includes one horizontal sensing element and one vertical sensing element in this embodiment, in other embodiments, the density of the sensing elements can be varied with the desired touch sensing resolution.

The sensing signal sensed by the vertical sensing element in each pixel structure can be outputted through the vertical sensing lines Y(1), Y(2), . . . , Y(2^{m}), wherein m is a positive integer. The sensing signal sensed by the horizontal sensing element in each pixel structure can be outputted through the horizontal sensing lines X(1), X(2), . . . , X(2ⁿ), wherein n is a positive integer. In the embodiment, it is assumed that the number of the vertical sensing lines is 2^{m}, and the number of the horizontal sensing lines is 2ⁿ. The number of the vertical or horizontal sensing lines is typically associated with the resolution of the display panel 310. For example, if each pixel structure has 3 RGB sub-pixels, every 4 adjacent pixel structures in the horizontal direction are connected to a same vertical sensing line, every 4 adjacent pixel structures in the vertical direction are connected to a same horizontal sensing line, and the number of the vertical and horizontal sensing lines are respectively 2^{m} and 2ⁿ, then the resolution of the display panel 310 is (4×2ⁿ)×3×(4×2^{m}).

Referring to FIG. 3 again, the gate-line driving circuit 340 and the data-line driving circuit 350 are configured to update the display data stored in each pixel structure of the display panel 310. In general, each pixel structure can be driven by one gate line and three data lines. The gate-line driving circuit 340 can input the gate-line control signal through a plurality of gate lines (not shown) to drive the thin film transistor of the pixel structure. The data-line driving circuit 350 can send the display data signal to each pixel structure through a plurality of data lines (not shown). The structure and driving manner of the gate line and the data line are well known in the art and will not be described in detail, so as not to unnecessarily obscure the present invention.

Referring to FIG. 3, 2^{m} vertical sensing lines Y(1), Y(2), . . . , Y(2^{m}) are connected to the vertical encoder 320, and 2ⁿ horizontal sensing lines X(1), X(2), . . . , X(2ⁿ) are connected to the horizontal encoder 330. The vertical encoder 320 consists of a plurality of basic logic gates (typically OR logic gates), to encode 2^{m} input signals into m output signals. In the embodiment, the vertical encoder 320 receives vertical sensing signals from the 2^{m} vertical sensing lines Y(1), Y(2), . . . , Y(2^{m}) and encodes the 2^{m} vertical sensing signals to obtain m vertical encoded signals 370, wherein the m vertical encoded signals 370 correspond to the logic combinations of the 2^{m} vertical sensing signals. Similarly, the horizontal encoder 330 receives and encodes horizontal sensing signals from the 2ⁿ horizontal sensing lines X(1), X(2), . . . , X(2ⁿ) to obtain n horizontal encoded signals 375.

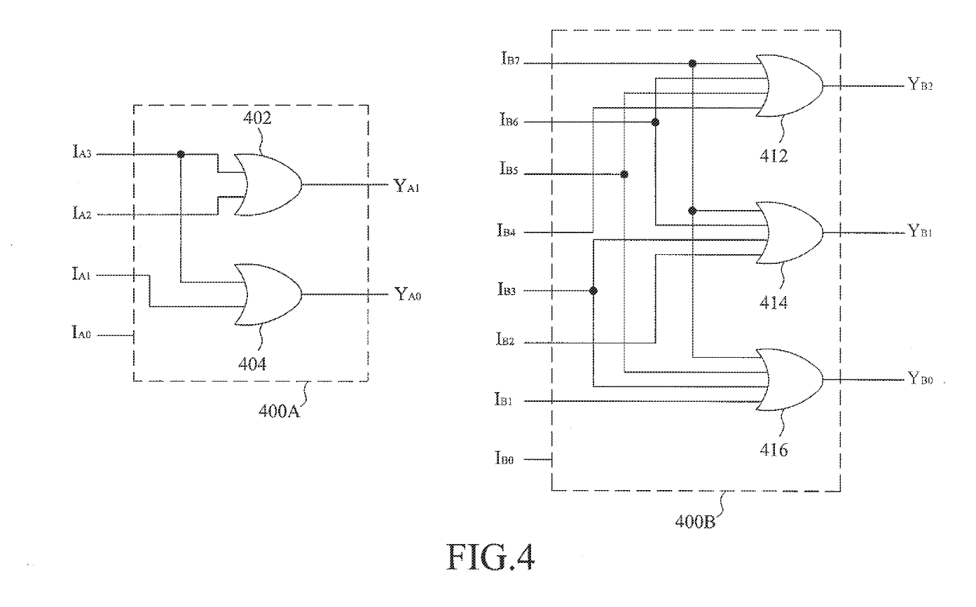

In general, the vertical encoder 320 and the horizontal encoder 330 used in the present invention can be any common encoder configuration having output ports fewer than the input ports. FIG. 4 illustrates logic circuits of a 4-to-2 (4 inputs and 2 outputs) encoder and an 8-to-3 (8 inputs and 3 outputs) encoder. From the teaching of the present invention and the embodiment of FIG. 4, those skilled in the art can easily recognize other 2^{p}-to-p (2^{p} inputs and p outputs) encoder configuration. Referring to FIG. 4, the 4-to-2 encoder 400A consists of two OR logic gates 402 and 404, including 4 input ports I_{A0}˜I_{A3} and 2 output ports Y_{A0}˜Y_{A1}. Below shows the true value table of the 4-to-2 encoder 400A.

| I_{A3} | I_{A2} | I_{A1} | I_{A0} | Y_{A1} | Y_{A0} |
|---|---|---|---|---|---|
| 0 | 0 | 0 | 1 | 0 | 0 |
| 0 | 0 | 1 | 0 | 0 | 1 |
| 0 | 1 | 0 | 0 | 1 | 0 |
| 1 | 0 | 0 | 0 | 1 | 1 |

Referring to FIG. 4 again, the 8-to-3 encoder 400B consists of three OR logic gates 412, 414, and 416, including 8 input ports I_{B0}˜I_{B7} and 3 output ports Y_{B0}˜Y_{B2}. Below shows the true value table of the 8-to-3 encoder 400B.

| I_{B7} | I_{B6} | I_{B5} | I_{B4} | I_{B3} | I_{B2} | I_{B1} | I_{B0} | Y_{B2} | Y_{B1} | Y_{B0} |
|---|---|---|---|---|---|---|---|---|---|---|
| 0 | 0 | 0 | 0 | 0 | 0 | 0 | 1 | 0 | 0 | 0 |
| 0 | 0 | 0 | 0 | 0 | 0 | 1 | 0 | 0 | 0 | 1 |
| 0 | 0 | 0 | 0 | 0 | 1 | 0 | 0 | 0 | 1 | 0 |
| 0 | 0 | 0 | 0 | 1 | 0 | 0 | 0 | 0 | 1 | 1 |
| 0 | 0 | 0 | 1 | 0 | 0 | 0 | 0 | 1 | 0 | 0 |
| 0 | 0 | 1 | 0 | 0 | 0 | 0 | 0 | 1 | 0 | 1 |
| 0 | 1 | 0 | 0 | 0 | 0 | 0 | 0 | 1 | 1 | 0 |
| 1 | 0 | 0 | 0 | 0 | 0 | 0 | 0 | 1 | 1 | 1 |

Returning to FIG. 3, after the encoders 320 and 330 encode the received 2^{m} vertical sensing signals and 2ⁿ horizontal sensing signals, the encoders 320 and 330 output the m vertical encoded signals 370 and the n horizontal encoded signals 375 respectively to the control chip 360. The control chip 360 can determine the vertical coordinate and the horizontal coordinate of the touch position based on the received encoded signals 370 and 375. In the embodiment, after the 2^{m} and 2ⁿ sensing lines are encoded through the encoders 320 and 330, the number of sensing lines can be reduced to m and n. As such, not only the frame width of the display device 300 can be reduced, but also the number of the pins required in the control chip 360 is decreased.

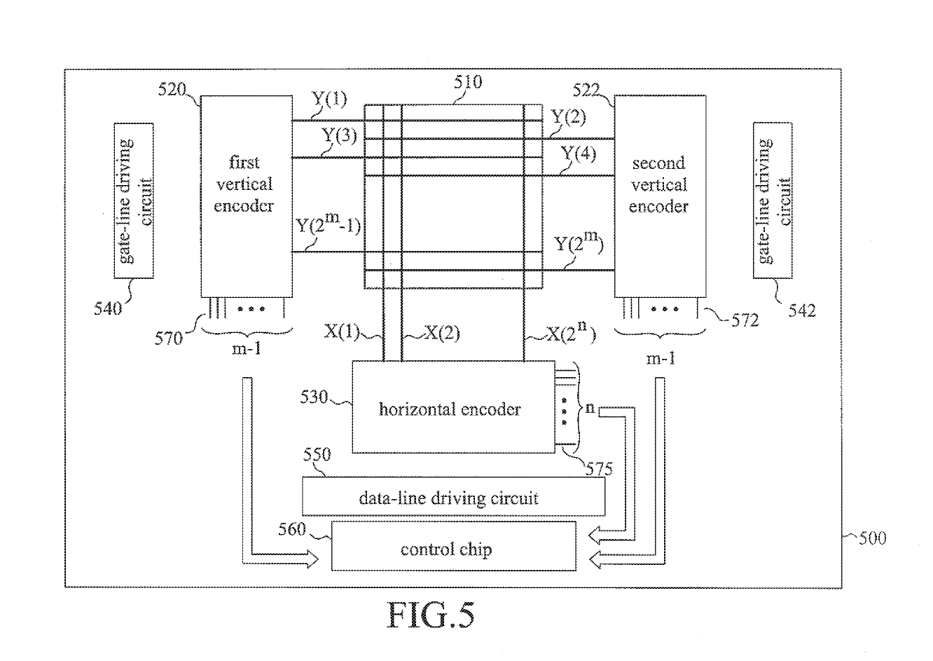

In the embodiment of FIG. 3, the vertical encoder 320 is disposed on the left side of the display panel 310. For the layout balance, the gate-line driving circuit 340 is thus disposed on the right side of the display panel 310. However, it is noted that the relative position of elements in the touch display device 300 is not limited thereto, which can be modified as appropriate, for example, as shown in the touch display device 500 of FIG. 5 (later described).

FIG. 5 illustrates a block diagram of the touch display device 500 in accordance with another embodiment of the present invention. The touch display device 500 includes a display panel 510, a first vertical encoder 520, a second vertical encoder 522, a horizontal encoder 530, gate-line driving circuits 540 and 542, a data-line driving circuit 550, and a control chip 560. The working principle of elements in the touch display panel 500 is identical to those in the FIG. 3 and not elaborated hereinafter. Compared to the embodiment of FIG. 3, the touch display panel 500 of FIG. 5 has two gate-line driving circuits 540 and 542 each to drive one half of the plurality of pixel structures in the display panel 510. Moreover, in the embodiment of FIG. 5, the odd number vertical sensing lines Y(1), Y(3), . . . , Y(2^{m}−1) are connected to the first vertical encoder 520 located on the left side of the display panel 510, while the even number vertical sensing lines Y(2), Y(4), . . . , Y(2^{m}) are connected to the second vertical encoder 522 located on the right side of the display panel 510. In other words, the vertical encoders 520 and 522 each receives sensing signals from 2^{m-1} vertical sensing lines and outputs m−1 vertical encoded signals 570 and 572 to the control chip 560. Similarly, the horizontal encoder 530 receives sensing signals from 2ⁿ horizontal sensing lines and outputs n horizontal encoded signals 575 to the control chip 560. In the embodiment, with the arrangement of the encoders 520 and 522, the gate-line driving circuits 540 and 542 can be disposed on left and right sides of the display panel 510 to obtain a better layout balance.

Compared to the conventional touch display device, in which all horizontal and vertical sensing lines are directly routing connected to the control chip, the touch display panel of the present invention adds a simple digital logic circuit to significantly reduce the number of sensing lines connected to the control chip. Consequently, the present invention can not only decrease the number of pins for external connection required in the control chip, but also reduce the overall dimension of the touch display device to further reduce the manufacturing cost.

The foregoing preferred embodiments are provided to illustrate and disclose the technical features of the present invention, and are not intended to be restrictive of the scope of the present invention. Hence, all equivalent variations or modifications made to the foregoing embodiments without departing from the spirit embodied in the disclosure of the present invention should fall within the scope of the present invention as set forth in the appended claims.

1. A touch display device, comprising:
a display panel comprising a plurality of sensing elements arranged in matrix form;
a plurality of horizontal sensing lines connected to the plurality of sensing elements, respectively;
a horizontal encoder for receiving and encoding a plurality of horizontal sensing signals from the plurality of horizontal sensing lines to form a plurality of horizontal encoded signals, wherein the number of the plurality of horizontal encoded signals is less than the number of the plurality of horizontal sensing signals; and
a control chip for receiving the plurality of horizontal encoded signals and determining a horizontal coordinate of a touch position on the display panel based on the plurality of horizontal encoded signals.

2. The touch display device of claim 1, wherein the number of the plurality of horizontal encoded signals is n, the number of the plurality of horizontal sensing signals is less than or equal to 2ⁿ, wherein n is a positive integer.

3. The touch display device of claim 1, further comprising:
a plurality of vertical sensing lines respectively connected to the plurality of sensing elements, wherein the plurality of vertical sensing lines are perpendicular to the plurality of horizontal sensing lines; and
a vertical encoder for receiving and encoding a plurality of vertical sensing signals from the plurality of vertical sensing lines to form a plurality of vertical encoded signals, wherein the number of the plurality of vertical encoded signals is less than the number of the plurality of vertical sensing signals, wherein the control chip is further for receiving the plurality of vertical encoded signals and determining a vertical coordinate of the touch position based on the plurality of vertical encoded signals.

4. The touch display device of claim 3, wherein the vertical encoder further comprises a first vertical encoder and a second vertical encoder disposed on two opposite sides of the display panel, wherein the first vertical encoder and the second vertical encoder are provided each for receiving a portion of the plurality of vertical sensing signals and outputting a portion of the plurality of vertical encoded signals.

5. The touch display device of claim 4, wherein the number of the vertical encoded signals outputted from the first vertical encoder is m−1, the number of the vertical sensing signals received by the first vertical encoder is less than or equal to 2^{m-1}, wherein m is a positive integer.

6. The touch display device of claim 3, wherein the horizontal encoder and the vertical encoder each consists of a plurality of OR logic gates.

7. The touch display device of claim 3, wherein the plurality of sensing elements further comprise a plurality of horizontal sensing elements and a plurality of vertical sensing elements, wherein the plurality of horizontal sensing lines and the plurality of vertical sensing lines are connected to the plurality of horizontal sensing elements and the plurality of vertical sensing elements, respectively.

8. The touch display device of claim 7, wherein the display panel further comprises a plurality of pixel structures, each pixel structure comprises three sub-pixels and a portion of the plurality of sensing elements.

9. An electronic apparatus, comprising the touch display device of claim 1, wherein the electronic apparatus is a mobile phone, a digital camera, a personal digital assistant, a laptop computer, a desktop computer, a television, a global positioning system, a head-up display, an aviation display, a digital frame, or a portable DVD player.
